(19) United States
(12) Patent Application Publication
(10) Pub. No.: US 2015/0033796 A1
(43) Pub. Date: Feb. 5, 2015

(54) MOLTEN GLASS PUNCH AND DIE CUTTING DEVICE AND METHOD OF USING THE SAME

(71) Applicant: Oregon Mosaics Company, Portland, OR (US)

(72) Inventor: William Collins, Portland, OR (US)

(73) Assignee: Oregon Mosaics Company, Portland, OR (US)

(21) Appl. No.: 14/446,676

(22) Filed: Jul. 30, 2014

Related U.S. Application Data
(60) Provisional application No. 61/862,037, filed on Aug. 4, 2013.

(51) Int. Cl. C03B 23/26; C03B 23/203

(52) U.S. Cl. CPC C03B 23/26; C03B 23/203
USPC 65/55; 83/620; 83/15

(57) ABSTRACT

A device and method for stamping or extruding molten glass sheet material into discrete glass parts defined by the shape of a metal or ceramic die may use force applied through one or more metal or ceramic punches to form precisely shaped glass parts. A molten glass sheet material may be positioned over the die and under the punches for processing. The molten glass material may be pushed through the die using, for example, hydraulic, pneumatic, electrical, and/or manual force to create a shearing action. The resulting glass part(s) may be subsequently moved to an annealing leer for controlled cooling while the residual sheet material may be gathered for recycling. Parts created with this method may be arranged into assemblies to combine colors for decorative effect, and reheated to unify them into a single solid piece comprised of an assembly of formerly discrete glass parts.

### FIELD

The present invention relates generally to a method and device for producing glass articles, and particularly to a molten glass punch and die cutting device and method of using the same.

### BACKGROUND

Artistic and decorative glass objects can be made by fusing (melting together) glass pieces of various colors. To make such decorative objects, pieces of glass are placed together, often overlapping, and fused into a single, usually relatively flat, glass object in a kiln.

Glass fused into such decorative objects can be used as stand alone artistic pieces, elements of stained glass objects such as church windows or glass lamp shades, architectural tiles, and other objects. After fusing, the resulting glass objects are sometimes slumped (heated to soften and shaped by gravity) into a shaped mold to make plates, bowls, and other three-dimensional shaped objects. Fused glass objects can also be used as components for other glass projects, such as those that are shaped by air pressure, such as blown glass vessels.

The glass used to make fused glass objects typically consists of shapes cut from flat glass sheets. Glass above a threshold temperature (e.g., melted glass) tends to even out to a thickness of about 6 mm. At this thickness, the forces of gravity spreading out the glass are approximately balanced with the cohesive forces. Consequently, glass fused to about this thickness will typically exhibit less unpredictable distortion.

Creating fused glass patterns and/or objects involves cutting the glass into shapes and arranging the pieces in a pattern (“laying out” the glass). Fusing heats the glass arrangement in a kiln to sufficient temperature to melt the glass together.

Current methods of making fused glass patterns can be difficult and time consuming because they require precise cutting of many glass pieces. In producing decorative glass patterns, conventional methods involve water jet cutting each of the glass pieces, which is typically time consuming and expensive because it and similar manual methods rely on “tracing” the outline of a shape, and scoring or cutting the shape along the path. Conventional methods of making decorative fused glass patterns are not well suited for creating mass-produced or high volume decorative glass pieces within a reasonable cost or time period because a path being cut in the glass can only be created from one point to another, in sequence, meaning no more than one part can be traced at a time in a machine or by hand. Further, manual methods are subject to repeatability issues and human errors. Mechanized computer controlled methods can eliminate human repeatability error and improve accuracy, but so long as they are tracing glass object outlines, do not represent a process able to create economies of scale in volume production. Therefore, the cutting of glass shapes using computer control remains relatively expensive. As a result, decorative glass objects that are mass produced rarely contain color patterns comprised of multiple colors of glass in tightly controlled designs that look similar from piece to piece, unless they are considerably more costly than objects without patterns.

Thus, for these and other reasons, there remains a need for an improved method of making decorative glass components and a machine for making the same.

### SUMMARY

The present disclosure concerns a method for stamping or extruding a molten glass sheet material into parts defined by the shape of a metal or ceramic die, using force that may be applied through one or more metal or ceramic punches. The glass sheet material may be positioned over the die and under the punches for processing when the glass is in a highly heated, or molten, form, giving it a lower viscosity than room temperature glass. The molten glass material may be pushed through the die using, for example, hydraulic, pneumatic, electrical, and/or manual force to effect a shearing action, thereby creating one or more glass parts. The resulting parts may be subsequently moved to an annealing leer for controlled cooling while the residual sheet material may be gathered for recycling. Parts created with this method may be arranged into assemblies to combine colors for decorative effect, thereby creating patterns in glass sheet material once the parts are reheated (e.g., fused in a kiln) to unify them into a single solid piece comprised of an assembly of formerly discrete glass parts.

Some examples of a molten glass extrusion process may include embedding patterns in decorative glass house-ware and hollow-ware products. In some examples, a large number of glass parts may be created with relatively low unit costs. Patterned glass objects formed according to the present disclosure may be formed into tiles, bowls, sconces, sinks, vases, etc.

One example of a device for creating one or more glass parts from a glass sheet may comprise one or more punches held in place by a punch holder; a die plate having a die plate thickness, and an upper die set plate configured to transfer force to the punches, thereby pressing the punches into the glass sheet and causing one or more glass parts to shear from the glass sheet through die plate holes, thereby creating one or more glass parts. In some examples, the die plate may comprise one or more die plate holes, each die plate hole extending through the die plate thickness, wherein each of the die plate holes is configured to correspond to one respective punch of the one or more punches, and wherein each die plate hole may be sized to be at least slightly larger than the respective punch so that each respective punch may fit through a respective die plate hole.

Some examples may include a stripper plate positioned between the one or more punches and the glass sheet, wherein the stripper plate may comprise one or more stripper plate holes corresponding to the punches and the die plate holes, wherein each stripper plate hole may be at least slightly larger than each corresponding punch, and wherein the stripper plate may be configured to prevent the glass sheet from adhering to the punches.

Some examples may include a lower die set plate positioned opposite the upper die set plate and/or a punch backer coupled to the punch holder and the upper die set plate.

Some examples may an include one or more alignment posts configured to keep the punch holder, the die plate, and the upper die set plate in alignment with one another. One or more spacers may be positioned between the die plate and the lower die set plate, wherein the spacers may be configured to create at least one empty space between the die plate and the lower die set plate. The at least one empty space may be configured to receive the one or more glass parts that are pressed through the die plate holes.

Some disclosed devices may comprise one or more brackets configured to allow for changing of one or more of the punch holder, punch backer, die plate, and stripper plate. Some examples may include one or more compression springs that may be configured to press the stripper plate and the punch holder away from one another when not compressed by an external force. Some examples may include a coupling coupled to the upper die set plate and configured to interface with a hydropneumatic cylinder. A hydropneumatic cylinder may thus be configured to press the one or more punches against the glass sheet with sufficient force to shear the glass sheet through the die plate holes, thereby creating the one or more glass parts.

One specific example of a device for creating one or more glass parts from a glass sheet may comprise a hydropneumatic cylinder press configured to impart pressure on an upper die set plate, a punch holder coupled to the upper die set plate, the punch holder configured to hold a plurality of punches, and a stripper plate, wherein a first stripper plate surface is separated from the punch holder by a plurality of compression springs, wherein the stripper plate comprises a plurality of stripper plate holes that extend through the entire thickness of the stripper plate from the first stripper plate surface to an opposite, second stripper plate surface, wherein each of the stripper plate holes is of the same shape as each of the punches, and wherein each of the stripper plate holes is at least slightly larger than each of the punches.

Disclosed devices further may include a die plate having an upper die plate surface and a lower die plate surface, and a plurality of die plate holes extending from the upper die plate surface to the lower die plate surface, wherein each of the die plate holes is of the same shape as each of the punches, and wherein each of the die plate holes is at least slightly larger than each of the punches. A glass sheet may be positioned between the second stripper plate surface and the upper die plate surface; and a lower die set plate may be spaced from the lower die plate surface via at least one spacer, wherein the upper die set plate may be configured to transfer forces from the hydropneumatic cylinder to press the punches against the glass plate, thereby shearing one or more glass parts from the glass sheet through the die plate holes, and wherein the lower die set plate may comprise a receiving surface configured for receiving the one or more glass parts as they are pressed through the die plate holes.

Methods of creating a glass object are also disclosed. In one method of creating a glass object, a first glass sheet may be provided and heated until it is molten. The first glass sheet may then be positioned within a tooling set, wherein said tooling set comprises at least one punch and a die plate having at least one die plate hole corresponding to the at least one punch, and at least one punch may be pressed against the first glass sheet with enough force to shear one or more portions of the first glass sheet through the at least one die plate hole, thereby separating the first glass sheet into one or more glass parts shaped like the at least one punch and a remaining glass webbing in the tooling set. The pressing may comprise pressing via a hydraulic, pneumatic, electrical, and/or magnetic cylinder, and/or via manual forces (e.g., using a hammer or lever).

In some methods, the first glass sheet may be coated with fiberglass that has been impregnated with a silica and plaster mix. In some methods, any coating present may be removed, such as with an ultrasonic cleaner and water, after the glass parts have been pressed through the die plate holes. The one or more glass parts may be cooled (or allowed to cool) before removing any coating present.

Some methods include removing the at least one punch and the die plate from the tooling set, replacing the at least one punch with at least one second punch, replacing the die plate with a second die plate, providing a second glass sheet, and pressing the at least one second punch against the second glass sheet to create a second set of glass parts.

A desired pattern of arranged glass parts may be created in a digital form, such as with design software such as Adobe Illustrator. The at least one punch and the die plate may be machined to create specific glass parts for the particular pattern of arranged glass parts. Some methods may include pressing a plurality of glass sheets of different colors and using different punch and die sets to create a plurality of different colored, sized, and shaped glass parts. For example, in some methods, a first glass sheet comprises a first color, a second glass sheet comprises a second color, and the first color is different from the second color. The glass parts may be arranged into a design or pattern and then heated in a kiln to a temperature sufficient to fuse the discrete glass parts together.

In some methods, the at least one punch may comprise a plurality of punches, the at least one die plate hole may comprise a plurality of die plate holes, the one or more glass parts may comprise a plurality of glass parts, and the tooling set is configured to cut the plurality of glass parts simultaneously.

The foregoing and other objects, features, and advantages of the invention will become more apparent from the following detailed description, which proceeds with reference to the accompanying figures.

### BRIEF DESCRIPTION OF THE DRAWINGS

FIG. 1 shows an illustrative, non-exclusive schematic representation of a front elevation view of one example of a hydropneumatic press that may be used to operate a punch and die system of creating glass parts according to the present disclosure.

FIG. 2 shows a partially exploded view of the hydropneumatic press of FIG. 1, with tooling according to the present disclosure in place under the press piston.

FIG. 3 shows a perspective view of one example of a tooling set that can be used to press molten glass according to the present disclosure.

FIG. 4 shows a perspective view of one example of a punch holder component of a tooling set according to the present disclosure.

FIG. 5 shows a perspective view of one example of a stripper plate component of a tooling set according to the present disclosure.

FIG. 6 shows a perspective view of one example of a die plate component of a tooling set according to the present disclosure.

FIG. 7 shows a top plan view of one example of the punch holder of FIG. 4, the stripper plate of FIG. 5, and the die plate of FIG. 6, overlaid on top of one another.

FIG. 8 shows a side elevation view of one example of a tooling set according to the present disclosure.

FIG. 9 shows a front elevation view of the tooling set of FIG. 8.

FIG. 10 shows a section view of the tooling shown in FIG. 8, taken along line 10-10 in FIG. 9.

FIG. 11 shows a front elevation view of one example of a tooling set with a sheet of molten glass in place between the stripper plate and the die plate.

FIGS. 12-21 show top plan views of various examples of layout for punches on a punch plate for tooling according to the present disclosure.

FIG. 22 shows a perspective view of one example of a glass plate after being pressed according to the present disclosure.

FIG. 23 shows a perspective view of one example of a glass part resulting from the methods disclosed herein.

FIG. 24, which is not drawn to scale, shows a section view of a coated glass plate according to the present disclosure.

FIG. 25 is a flow chart showing one example of a method of pressing glass parts according to the present disclosure.

FIG. 26 shows a top plan view of one example of a layout or design for a final glass piece made according to the present disclosure.

### DETAILED DESCRIPTION

As used in this application and in the claims, the singular forms “a,” “an,” and “the” include the plural forms unless the context clearly dictates otherwise. Additionally, the term “includes” means “comprises.” Although the operations of examples of the disclosed method may be described in a particular, sequential order for convenient presentation, it should be understood that the disclosed examples may encompass an order of operations other than the particular, sequential order disclosed. For example, operations described sequentially may in some cases be rearranged or performed concurrently. Further, descriptions and disclosures provided in association with one particular example are not limited to that example, and may be applied to any example disclosed herein. Moreover, for the sake of simplicity, the attached figures may not show the various ways in which the disclosed system, method, and apparatus may be used in combination with other systems, methods, and apparatuses.

Overview

The current disclosure concerns tooling and a mechanism for pressing the tooling onto molten glass (e.g., a molten glass sheet) to form glass parts of particular shape or shapes, said shape of the parts being determined by a punch and die set, which are components of the tooling. In some examples, the punch and die glass press of the present disclosure may enable a method of glass cutting having a level of precision similar to that of CNC machining. In disclosed examples, rather than pressing glass into a mold as with many conventional techniques, molten glass may be pressed through a die to form glass parts in the shape of the die.

In some examples, the mechanism for pressing the tooling may be a mechanical press, such as a hydraulic or pneumatic press or combination of the above. In other examples, the tooling may be pressed manually or by some other mechanism (e.g., with a hammer, lever, or mallet) capable of transferring enough force to press the molten glass through the punch and die tooling. In some examples, a force of at least 200 lbs/in², at least 300 lbs/in², at least 400 lbs/in², at least 500 lbs/in², at least 600 lbs/in², at least 700 lbs/in², at least 800 lbs/in², at least 900 lbs/in², and/or 1000 lbs/in² or more may be applied to the tooling. In one specific example, around 500 pounds of force per square inch may be applied to the tooling to press the molten glass (e.g., a 3 mm thick glass sheet raised to a temperature of about 1475-1550° F.) through the die, but more or less force may be appropriate for different examples (e.g., different thicknesses of glass, different temperatures of glass, different colors of glass, different types of glass, etc). For thicker glass (e.g., 6 mm glass sheets), more force may be appropriate, such as around 600-900 lbs/in². Similarly, more or less force may be appropriate for different types of glass, such as for crystal glass (glass with lead in it) or other types of glass with varying chemistries and/or varying softening points or other mechanical properties.

The tooling and press may be machine-operated (e.g., robotically or automatically operated; computer-controlled) or operated by one or more human operators, or some combination of the above. In some examples, the device of the present disclosure may be configured to cut molten glass parts with great precision, at a lower cost than conventional glass cutting processes, such as water jet cutting.

The present disclosure also concerns a process for stamping or extruding molten glass sheet material into parts defined by the shape of a metal or ceramic die using force applied to one or more metal or ceramic punches to punch (e.g., press, push, stamp, and/or extrude) the molten glass through the die. In some examples, a glass sheet material may be positioned over the die and under the punches for processing when the glass is in a highly heated, or molten form, giving it a lower viscosity than room temperature glass. The molten glass material may be pressed (e.g., pushed) through the die using, for example, hydraulic, pneumatic, electrical, or manual force to effect a shearing action, thereby forming a glass part or parts the same shape as the die. The resulting part(s) may be subsequently moved to an annealing leer for controlled cooling while the residual sheet material (“webbing”) may be gathered for recycling. Parts created with this method may be arranged into assemblies to combine colors for decorative effect, thereby creating patterns in glass sheet material once the parts are reheated to unify them into a single solid piece comprised of an assembly of formerly discrete glass parts. Such methods according to the present disclosure may create a work of decorative glass based on a design created digitally or electronically, such as with design software on a computer (e.g., with CAD programs, design software, Adobe Illustrator, etc).

Press

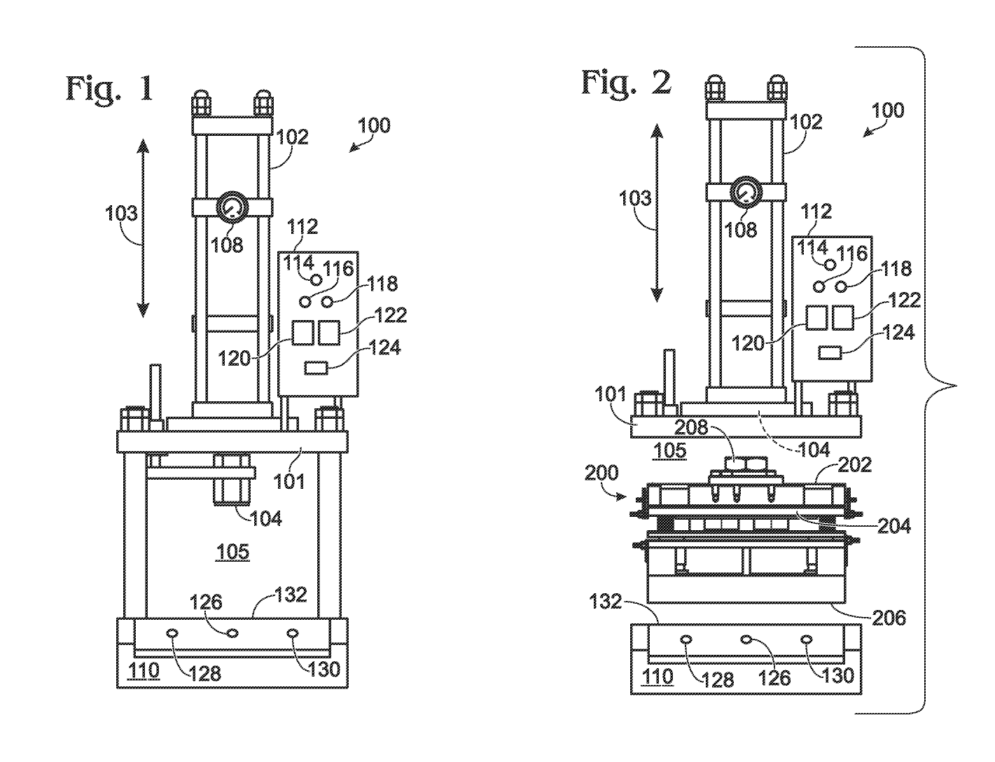

FIG. 1 shows one example of a press 100 that may be used with custom tooling (e.g., a punch and die set) according to the present disclosure. Press 100 may generally include a frame, or support structure 101 that may support a cylinder 102, such as a hydropneumatic cylinder 102. Cylinder 102 may move up and down in the directions indicated by arrow 103 in a stroke cycle, such that a lower portion 104 of cylinder 102 may move up and down within a space 105 created by the support structure 101 under lower portion 104 of cylinder 102. For example, during a stroke cycle, cylinder 102 may move from its highest position, to a position where lower portion 104 is closer to a bottom portion 110 of press 100, and then back again to its highest position. By completing a stroke cycle, cylinder 102 may thereby press (e.g., exert force or pressure on) an item positioned within space 105, positioned adjacent lower portion 104 of cylinder 102, typically exerting pressure for only a brief period of time (e.g., the stroke cycle length).

Some conventional hydraulic presses may be powerful but too slow to press molten glass before it cools too much to be pressed through the dies. By using a hybrid hydraulic and pneumatic cylinder press, in some examples, a stroke may be achieved that is quick enough to ensure that the glass is pressed through the dies while the glass temperature is still sufficiently high. A hybrid pneumatic-hydraulic press may be fitted with the punch and die tooling as described below. Such a combination may combine the speed of movement of a pneumatic press with sufficient force to complete the cycle using the greater pressures of a hydraulic system for the portion of the stroke during which the glass is forced through the die. This combination of speed of movement for the punch and magnitude of force applied against the glass may enable the glass to be forced through the die before it cools to a solid state while still applying forces adequate to the pressures required.

In some examples, press 100 may have a total stroke length of from about 0 mm to about 300 mm. For example, press 100 may have a total stroke length about at least 5 mm, at least 10 mm, at least 50 mm, at least 100 mm, at least 150 mm, at least 200 mm, at least 250 mm, and/or 300 mm or more. In one specific example, press 100 may have a total stroke length of around 100 mm total travel (e.g., cylinder 102 may travel around 100 mm down toward bottom portion 110 of press 100, and then travel around 100 mm back up towards the highest position). In one example, press 100 may be configured to have a fast, pneumatic stroke of around 95 mm and a power stroke of around 5 mm while the punch travels through the molten glass material, for a total of around 100 mm travel during a stroke. In some examples, the power stroke may be from about 0 mm to about 10 mm. In some examples, the power stroke may be from about 3 mm to about 9 mm while the press meets resistance of the molten glass material as it is pressed through the die.

In some examples, the stroke cycle, or the time it takes for the press to travel the total stroke length may be from about 0 seconds to about 4 seconds or longer. In some examples, the stroke cycle may be from about 2 seconds to about 4 seconds. In one specific example, the stroke cycle may be about 4 seconds. Suitable presses may be custom-made, or modified versions of commercially available presses. For example, a stamping and punching machine may be obtained from Dongguan July Hydropneumatic Equipment Co., Ltd. (Guangdong, China) and modified (such as by changing its shape and/or dimensions) for particular applications.

The press 100 may include a pressure gauge 108 which may be configured to indicate the set pressure to be applied by the cylinder 102 during its stroke cycle. In some examples, the pressure gauge 108 may be adjustable to set the pressure to be applied by the cylinder 102.

The press 100 also may include a control box 112 that may include a number of controls, buttons, lights, indicators, and/or switches that may be configured to operate various functions and parameters of the press 100. For example, control box 112 may include a power indication light 114, a power switch 116, a mode selector 118 (e.g., to select manual or automatic mode), one or more timers (e.g., a pre-press timer 120 and a power press timer 122), and/or a counter 124 that may be configured to count the completed stroke cycles performed by cylinder 102.

Press 100 also may include a number of buttons, switches, indicators, lights, and/or controls adjacent bottom portion 110 of press 100. For example, as shown in FIG. 1, press 100 may include an emergency safety switch 126 which may be configured to stop the press mid-stroke in case of an emergency. Disclosed presses also may include one or more buttons 128, 130 that may be configured to manually operate the cylinder 102. For example, a first button 128 may be configured to manually move cylinder 102 up to the top of the stroke cycle (e.g., at its highest position), and a second button 130 may be configured to move cylinder 102 down to the bottom of the stroke cycle (e.g., at its lowest position). The distance cylinder 102 travels up and down may be referred to as its stroke, or stroke length. Support structure 101 of press 100 may include a flat surface 132 adjacent bottom portion 110 of press 100, which may define the lower boundary of space 105 and serve as a support for an item to be placed within space 105 (e.g., an item to be pressed by cylinder 102, such as a punch and die tooling set as will be discussed below).

While FIG. 1 shows a press that may be used with punch and die tooling according to the present disclosure to operate a molten glass extrusion process, any suitable mechanism that may supply enough force to press the molten glass through the die may be used. Further, while press 100 of FIG. 1 includes a hydropneumatic cylinder 102, any type of cylinder (or other means of applying pressure to the tooling) may be used, additionally or alternatively, that may be configured to supply appropriate forces within a sufficient amount of time (e.g., before the molten glass cools too much to be pushed through the die) to the tooling according to the present disclosure.

FIG. 2 is a partially exploded view that generally shows placement of a set of plates, or tooling, 200 that may be placed within space 105 between cylinder 102 and bottom portion 110 of press 100. In some examples, when cylinder 102 moves down towards bottom portion 110 of press 100, cylinder 102 may press on an upper surface 202 of the tooling 200, thereby compressing one or more springs 204 and moving the plates closer together, as will be explained in further detail, below. A lower surface 206 of tooling 200 may rest on flat surface 132 of press support structure 101 near bottom portion 110 of press 100.

Cylinder 102 may exert force or pressure on upper surface 202 of tooling 200 directly or indirectly. In some examples, cylinder 102 may directly press on upper surface 202, thereby causing compression of springs 204. In other examples, cylinder 102 may indirectly press on upper surface 202, such as by pressing on a large nut, bolt, plate, coupling, fitting, or other component (e.g., a coupling 208 adjacent upper surface 202 of tooling 200), thereby pressing upper surface 202 down and compressing springs 204. In some examples, coupling 208 may be used to couple or secure tooling 200 to press cylinder 102.

Tooling

FIG. 3 shows a close up view of tooling 200, removed from press 100 for clarity. Tooling 200 may include a plurality of plates that interact with one another to effectively create a molten glass press, or a molten glass punch and die set, that may, in some examples, cut pieces of glass into precise shapes. In some examples, tooling 200 may include a die set consisting of an upper die set plate 210 and a lower die set plate 212. Tooling 200 may be arranged under a press (or other mechanism for exerting pressure to compress one or more springs 204), such as under cylinder 102 of FIGS. 1 and 2, such that upper die set plate 210 is positioned adjacent lower portion 104 of cylinder 102, and lower die set plate 212 is positioned adjacent flat surface 132 and bottom portion 110 of press support structure 101.

In between upper and lower die set plates 210, 212, tooling 200 may also include a punch backer 214, a punch holder 216 and associated punches 217, a stripper plate 218 and associated stripper plate holes 219, a die plate 220, and/or one or more spacers or support posts 222. Punches 217, punch holder 216, stripper plate 218, and/or die plate 220 each may be custom-made to interact with one another to create a set of one or more glass parts for a particular pattern or design. These plates may be removable from upper and lower die set plates 210, 212 and replaced with a different set of corresponding plates in order to produce a different set of glass parts.

The plates may be made by any suitable method. In one specific example, the plates may be milled using a CNC machine. The plates may be configured to press or extrude one or more glass parts from a sheet of molten glass, and a new sheet of molten glass may be placed within the tooling for each stroke of the press to produce more glass parts of the same pattern of punches (e.g., the corresponding set of punches 217, die plate 220, and stripper plate 218 may be used repeatedly to press a plurality of parts from a plurality of molten glass sheets, one glass sheet at a time). Typical plates may be designed to create between six and eight glass parts per press (e.g., the punch holder 216 may contain, in one example, six punches, with stripper plate 218 containing six corresponding stripper plate holes 219 and die plate 220 containing six corresponding die plate holes); however, more or fewer glass parts also may be created. In some examples, each set of plates may be patterned to create between 1 and 100 or more glass parts. In some examples, each set of plates and punches may be machined to create between around four and around twelve parts each time the punches are pressed against a molten glass sheet newly positioned within tooling 200.

In some examples, one or more spacers and/or support posts 222 may be positioned under die plate 220, such as between die plate 220 and lower die set plate 212, to help prevent die plate 220 from bending or sagging. Tooling 200 also may include one or more alignment or guide posts, cylinders, or pins 224 that may be configured to help keep the plates of tooling 200 properly aligned with one another. In some examples, at least one of the guide posts 224 may be a thick metal post with a bushing.

During use, a sheet of molten glass (not shown in FIG. 3) may be positioned between stripper plate 218 and die plate 220. As force is applied to upper die set plate 210, springs 204 may be compressed and punch backer 214, punch holder 216, and punches 217 may be forced downward towards lower die set plate 212. With sufficient force, springs 204 may be configured to compress enough that punches 217 travel through corresponding stripper plate holes 219 and press the molten glass positioned between stripper plate 218 and die plate 220. As punches 217 are pressed onto the molten glass plate, one or more glass parts (not shown in FIG. 3) in the shape of punches 217 are created and pass through corresponding holes in die plate 220. The created glass parts may, in some examples, collect in a space 226 between die plate 220 and lower die set plate 212. The glass parts may then be removed for further processing, and the stroke performed again using a newly positioned glass sheet (e.g., a different glass sheet than was just pressed) to create more parts using the same plates in tooling 200.

Punch backer 214 may be coupled to upper die set plate 210 in any suitable fashion. For example, one or more brackets 228 may be secured to upper die set plate 210, such as by one or more screws 229 or other fasteners. Brackets 228 may interface with one or more pins 232 of punch backer 214 and one or more clamps (e.g., a ratchet clamp 230) may be used with brackets 228 to releasably couple punch backer 214 to upper die set plate 210. In some examples, the mechanism of securing punch backer 214 to upper die set plate 210 may be a quick release mechanism, allowing removal and replacement of different punch backers 214 and punch holders 216 without requiring use of tools.

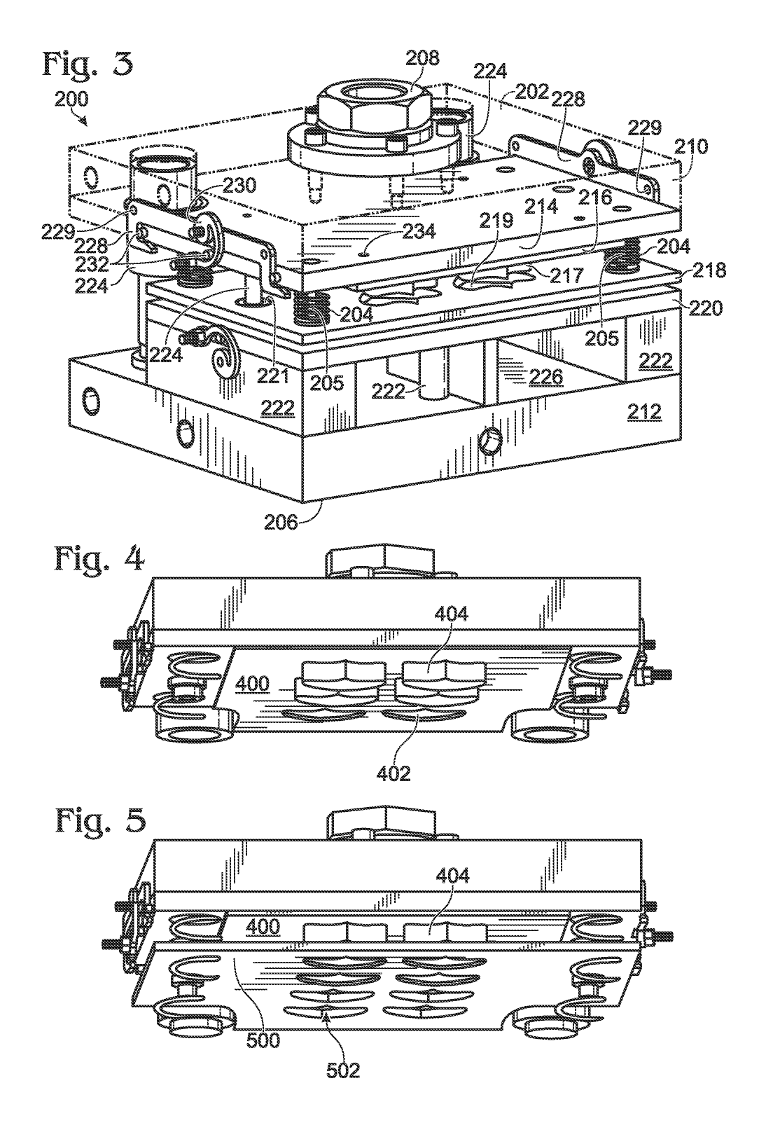

In some examples, tools (e.g., screwdrivers and/or wrenches) may be used to switch out one punch backer 214 and punch holder 216 for different ones. In this manner, the same die set (e.g., upper and lower die set plates 210, 212) may be used with different punch holders (and corresponding stripper plates 218 and die plates 220) in order to create different numbers, sizes, and shapes of glass parts. Punch backer 214 may be coupled to punch holder 216 by, for example, one or more screws or other fasteners 234. In some examples, several different punch holders may be switched out with one another within tooling set 200 using the same punch backer 214. In some examples, punches 217 may be integrally formed with punch holder 216. In other examples, punch holder 216 may be formed with punch holes (e.g., punch holes 402 of FIG. 4) that are sized around 0.005″ larger than the perimeter of the punches 217, such that each of the punches 217 may be nested with a friction fit inside a respective punch hole in punch holder 216. In some examples, punches 217 may fit more loosely within the holes of punch holder 216, and/or punches 217 may be secured to punch backer 214 via one or more fasteners or screws.

Stripper plate 218 may be coupled to or acted on by springs 204, which may be biased to push stripper plate 218 away from punch holder 216 and punches 217 when no pressure (or insufficient pressure) is being applied to tooling 200. In this manner, stripper plate 218 may, in some examples, advantageously prevent or at least partially or substantially prevent, molten glass from adhering to punches 217 and/or punch holder 216. In some examples, springs 204 may each include a spring pin 205 passing through corresponding spring pin holes in stripper plate 218, punch backer 214, and/or die plate 220 to help keep them aligned.

Stripper plate 218 may be provided with one or more stripper plate holes 219 corresponding to punches 217 in a particular punch and die set. In some examples, stripper plate 218 may include one stripper plate hole 219 corresponding to each respective punch 217 coupled to punch backer 214. Stripper plate holes 219 may be sized such that they are slightly larger than punches 217. For example, stripper plate holes 219 may be about 1/16″ larger than punches 217 around the entire perimeter of punches 217. Stripper plate 218 also may be provided with one or more guide post holes 221 to accommodate a guide post or guide pin 224. Such guide posts 224 may help to keep stripper plate 218 substantially in correct alignment with the other plates of tooling 200. While not visible in FIG. 3, the other plates of the tooling (e.g., die plate 220 and punch backer 214) also may be provided with guide post holes 221 to accommodate said guide pins 224.

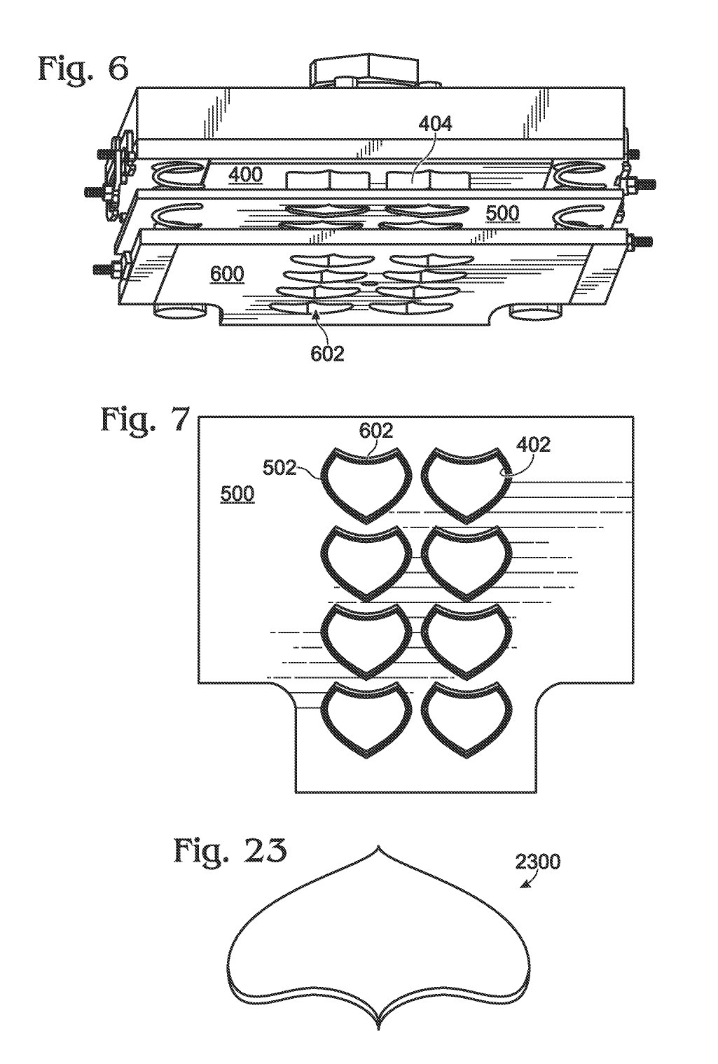

Die plate 220 may be releasably secured to the one or more spacers and/or support posts 222 (e.g., such as by one or more screws or other fasteners). Die plate 220 may include one or more die plate holes (e.g., die plate holes 602 of FIG. 6) that correspond to punches 217, such that glass parts created in the shape of punches 217 may be pressed through the die plate holes. The die plate holes may be sized such that they are slightly larger than punches 217. For example, the die plate holes may be about 0.0015″ larger than punches 217 around the entire perimeter of the punches.

In some examples, upper and lower die set plates 210, 212 may each be from about 0.5 to about 3 inches thick. In one example, upper and lower die set plates 210, 212 may each be about 1 inch thick. In some examples, stripper plate 218 may be from about 0.125 to about 0.5 inches thick. In one example, stripper plate 218 may be about 0.25 inches thick. In some examples, die plate 220 may be from about 0.25 to about 1 inch thick. In one example, die plate 220 may be about 0.5 inches thick. In some examples, punch holder 216 may be from about 0.125 to about 1 inch thick. In one example, punch holder 216 may be about 0.375 inches thick. In some examples, punch backer 214 may be from about 0.125 to about 1 inch thick. In one example, punch backer 214 may be about 0.625 inches thick. The various plates may have a greater or lesser thickness depending on the specific tooling requirement. In some examples, the plates may be any thickness so long as they provide sufficient rigidity for the given application. In some examples, upper limits for plate thicknesses may be influenced by weight, cost, length of the punches, and the parameters of the press (e.g., stroke length and force). Suitable materials for the tooling components may include ceramics and/or metals, such as steel, titanium, aluminum, nickel, platinum, magnesium, cobalt, chromium, tungsten, combinations of the above, and any other suitable materials.

FIG. 4 shows one example of a punch holder 400 that may be used with, for example, the tooling set 200 of FIG. 3. Punch holder 400 may be an example of punch holder 216 of FIG. 3, and/or may be used in tooling 200 in place of punch holder 216. Punch holder 400 may include one or more punch holes 402, where each punch hole 402 is configured to hold a punch 404 (but two punch holes 402 are shown without punches 404 in FIG. 4, for clarity). Punch 404 may be an example of punch 217 of FIG. 3. Each of the punches 404 may be nested within a respective punch hole 402, where each of the punch holes 402 is sized to be slightly larger than each respective punch 404. Punch holder 400 may be configured to prevent, or at least substantially prevent, movement or rotation of punches 404. Punches 404 may be drilled and tapped to be provided with through holes to be secured to a punch backer 214 (shown in FIG. 3) via one or more fasteners (e.g., screws).

In some examples, punch holes 402 and punches 404 may be sized such that there is a friction fit between each respective punch 404 and punch hole 402. For example, each of the punch holes 402 may be from about 0.001″ to about 0.01″ larger than the punches 404 around the entire perimeter of the punch. In one specific example, each of the punch holes 402 may be about 0.007″ larger than each of the punches 402. In other examples, each of the punch holes 404 may be more than 0.007″ larger than each of the punches 404. In some examples, punches 404 may be otherwise secured to the tooling (e.g., coupled to the punch backer as described above).

FIG. 5 shows one example of a stripper plate 500 configured to correspond to the punches 404 of punch holder 400. Stripper plate 500 may be an example of stripper plate 218 of FIG. 3, and/or may be used in tooling 200 in place of stripper plate 218. Stripper plate 500 may include stripper plate holes 502 (which may be an example of stripper plate holes 219 of FIG. 3), each of which may be about 0.10″ larger than each of the punches 404, around the entire respective perimeter of each of the punches 404. As discussed above with respect to stripper plate 218, stripper plate 500 may be configured to prevent, or at least partially or substantially prevent, glass from sticking to punches 404 during the pressing process and/or to at least partially prevent the glass from getting stuck in the space between the punches 404. As the springs of the tooling push the punches up and away from stripper plate 500 after pressure is removed (e.g., at the end of the press stroke) and away from the associated die plate, stripper plate 500 may be configured to remove the excess glass or webbing from punches 404 and/or prevent said excess glass from tightening around one or more punches 404, so that said excess glass may be removed easily from the tooling for recycling. Glass tends to shrink as it cools, and might tighten around punches, but the stripper plate may, in some examples, overcome such tightening around the punches, thereby resulting in the excess glass falling off the punches.

FIG. 6 shows one example of a die plate 600 configured to correspond to the punch holder 400 and stripper plate 500, as described above. Die plate 600 may be an example of die plate 220 of FIG. 3, and/or may be used in tooling 200 in place of die plate 220. Die plate 600 may be provided with one or more die plate holes 602, where each die plate hole 602 corresponds to a punch 404 on punch holder 400. Each respective die plate hole 602 may be slightly larger than the corresponding punch 404. In one example, each die plate hole 602 may be around 0.015″ bigger than the respective punch 404, around the entire perimeter of the respective punch 404. Die plate holes 602, in association with punches 404, may be configured to create a shearing force to create the desired glass parts. For example, punches 404 may push molten glass material through each of the die plate holes 602, thereby shearing the glass through die plate holes 602, in order to produce a number of glass parts in sizes and shapes corresponding to the punches 404 and die plate holes 602 (e.g., in an example having a die plate with 10 die plate holes, a glass part may be produced for each die plate hole, thereby creating a total of 10 glass parts with a single press stroke).

Each set of punches 217,404 desired to be used to produce glass parts according to the present disclosure may be used with a corresponding set of plates (e.g., a punch holder 216, 400, a stripper plate 218, 500, and a die plate 220,600), with corresponding holes as discussed above in connection with FIGS. 4-6. The plates may be any suitable size to fit with the tooling and/or press used in the process. In one specific example, the plates may be around 14″ in width and around 12″ in length. However, the tooling and press may be sized to house smaller or larger plates and punches, as desired for the particular application or pressing machine. Each plate set and associated punches may be configured to press one or more glass parts of any shape or size. In some examples, it may be preferable to size the punches such that they are at least as wide as the glass is thick. In some examples, all of the parts produced by a given set of plates and punches may be the same shape and size. In other examples, a set of plates and punches may be configured to produce a pattern of glass shapes of various different shapes and/or sizes, as desired.

The punches and dies may be made in any suitable fashion. For example, a CNC machine may be used to mill a set of punches and dies for a particular pattern to be placed in the tooling. In some examples, a wire EDM (electrical discharge machine) may be CNC-controlled to trace and cut out the punches and dies from, for example, hardened steel plates.

FIG. 7, which is not drawn to scale, shows a top plan view of one example of punch holder 400 of FIG. 4, stripper plate 500 of FIG. 5, and die plate 600 of FIG. 6, overlaid on one another to show an example of their relative sizes, although only the stripper plate 500 is visible, except in the areas of stripper plate holes 502. As seen in FIG. 7, relative to one another, stripper plate holes 502 may be slightly larger than die plate holes 602 of die plate 600, which in turn may be slightly larger than punch holes 402 of punch holder 400.

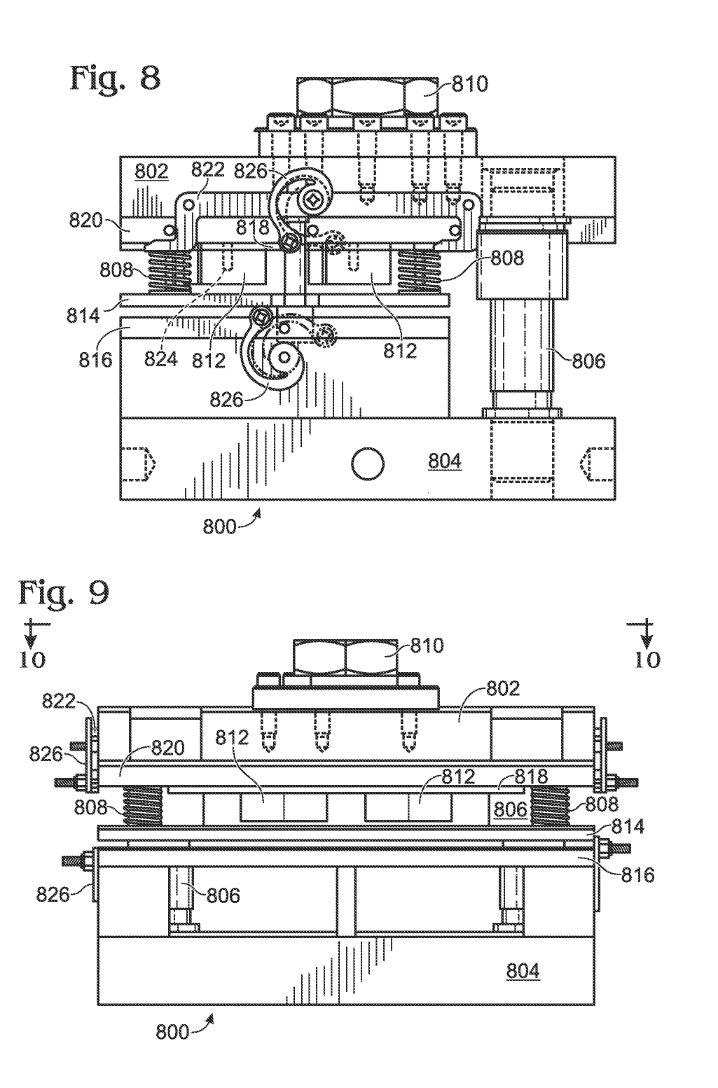

FIGS. 8-11 show various views and examples of tooling sets similar to the tooling 200 of FIG. 3.

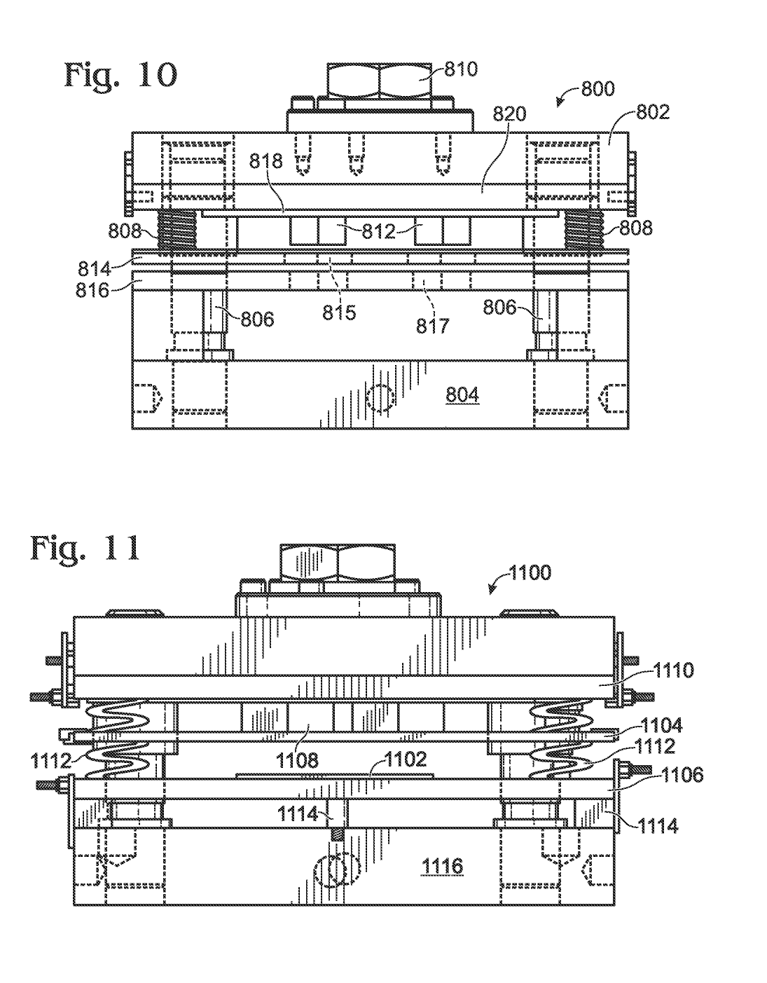

FIGS. 8-10 show a tooling set 800 having a configuration similar to the tooling 200 of FIG. 3. An upper die set plate 802 and a lower die set plate 804 may sandwich a number of different plates that may be switched out to produce different sets of glass parts. A number of guide posts or pistons 806 may help keep upper and lower die set plates 802, 804 in alignment with one another, and also may be configured to allow motion of the upper and lower die set plates 802, 804 towards and away from one another. Compression of springs 808, such as via pressure applied to coupling 810 (e.g., via a press, not shown in FIGS. 8-10), may allow the upper die set plate 802 to be pressed downward towards the lower die set plate 804. Such movement of the upper die set plate 802 may, in turn, press a set of punches 812 through corresponding holes in a stripper plate 814 and a die plate 816. Stripper plate holes 815 and die plate holes 817 are visible in FIG. 10. The punches 812 may be secured to the upper die set plate 802 via a punch holder 818, a punch backer 820, a bracket 822 (FIGS. 8-9), and/or a number of fasteners 824 (FIG. 8) in some examples.

Ratchet clamps 826 (FIGS. 8-9) may be configured to releasably secure the die plate 816 and punch backer 820 to the tooling set 800 so that the respective plates and punches 812 may be removed and replaced with a different set of plates and punches corresponding to different glass parts to be pressed. In use, a molten glass plate may be positioned between stripper plate 814 and die plate 816, and, when pressed into the glass, punches 812 may force glass parts to shear through die plate holes 817 that are in the shape of punches 812. Then, the pressed glass parts and excess glass webbing material may be removed from tooling set 800, and a different sheet of molten glass may be positioned within the tooling set, and another press stroke performed to produce another set of glass parts.

The process may be repeated as many times as desired. In some examples, the number of glass parts needed to create a certain number of finished patterns may be calculated, and then the appropriate number of presses performed. For example, if 100 copies of a glass pattern were desired, and each finished pattern required 10 glass parts of type A, 5 glass parts of type B, and 20 glass parts of type C, then a total of 1000 type A parts, 500 type B parts, and 2000 type C parts would be required for those 100 copies of the pattern. In one example, a first set of punches, along with the corresponding stripper plate and die plate, may be created to press out 10 type A glass parts at each press (e.g., there may be 10 punches, 10 corresponding die plate holes, and 10 corresponding stripper plate holes). Similarly, a second set of punches, stripper plate, and die plate, may be created to press out, for example 8 type B parts, and a third set of punches, stripper plate, and die plate may be created to press out 6 type C parts. In this example, the press stroke would need to be repeated at least 100 times with 100 different sheets of glass (e.g., replacing the pressed glass sheet with a different glass sheet after each press) using the first set of punches, stripper plate, and die plate to create at least 1000 type A parts. Then the first set of punches, stripper plate, and die plate may be removed and replaced with the second set of punches, stripper plate, and die plate. The press stroke may then be repeated at least 63 times with 63 different glass sheets to create at least 500 type B parts. Similarly, the second set of punches, stripper plate, and die plate may then be removed and replaced with the third set of punches, stripper plate, and die plate. The press stroke may then be repeated at least 334 times with at least 334 different glass sheets to produce at least 2,000 type C parts. Of course any number of presses may be performed depending on the given pattern and number of copies desired.

FIG. 11 shows an elevation view of one example of a tooling set 1100 with a sheet of molten glass 1102 in place between a stripper plate 1104 and a die plate 1106. In some examples, glass sheet 1102 may be approximately the same dimensions (e.g., length and width) as stripper plate 1104 and/or die plate 1106, so as not to significantly overhang over the edges of the plates. In other examples, glass sheet 1102 may be sized such that it is smaller or larger than stripper plate 1104 and/or die plate 1106, with any excess being removable for recycling. For example, as shown in FIG. 11, molten glass sheet 1102 may be smaller than stripper plate 1104 and/or die plate 1106. In some examples, the glass sheet may be sized to be approximately the same size as the footprint of punches 1108 held in place by a punch backer 1110. As pressure is applied to the tooling set 1100, springs 1112 may be compressed, thereby pressing the punches 1108 through holes (not shown in FIG. 11) in the stripper plate 1104 in order to press the molten glass sheet 1102 such that glass sheet 1102 shears and glass parts are forced through holes (not shown in FIG. 11) in die plate 1106. One or more support posts or spacers 1114 may create a space between die plate 1106 and a lower die set plate 1116 into which the glass parts may fall and collect.

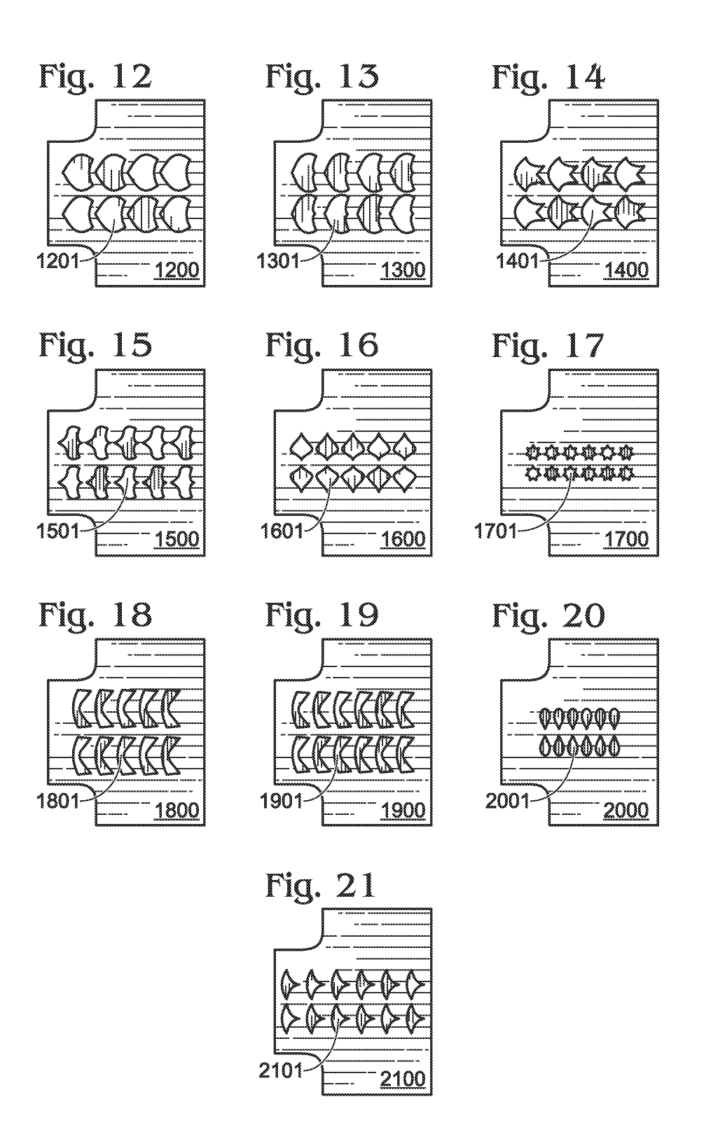

FIGS. 12-21 show top plan views of various examples of layouts for punches on a punch plate for tooling according to the present disclosure. FIG. 12 shows one example of a punch plate or punch holder 1200 with 8 punches 1201 positioned on the plate 1200. Similarly, FIG. 13 shows an example of a punch plate 1300 with 8 punches 1301 positioned on the plate 1300. Similarly, FIG. 14 shows an example of a punch plate 1400 with 8 punches 1401 positioned on the plate 1400. FIG. 15 shows an example of a punch plate 1500 with 10 punches 1501 positioned on the plate 1500. FIG. 16 shows an example of a punch plate 1600 with 10 punches 1601 positioned on the plate 1600. FIG. 17 shows an example of a punch plate 1700 with 12 punches 1701 positioned on the plate 1700. FIG. 18 shows an example of a punch plate 1800 with 10 punches 1801 positioned on the plate 1800. FIG. 19 shows an example of a punch plate 1900 with 12 punches 1901 positioned on the plate 1900. FIG. 20 shows an example of a punch plate 2000 with 12 punches 2001 positioned on the plate 2000. FIG. 21 shows an example of a punch plate 2100 with 12 punches 2101 positioned on the plate 2100.

As seen in FIGS. 12-21, punches may be any size or shape and arranged in any suitable manner on a punch plate. While FIGS. 12-21 show 8, 10, or 12 punches on a given punch plate, more or fewer punches may be provided on a given punch plate, as desired. In some examples, a single punch plate may be provided with a plurality of different sizes and/or shapes of punches.

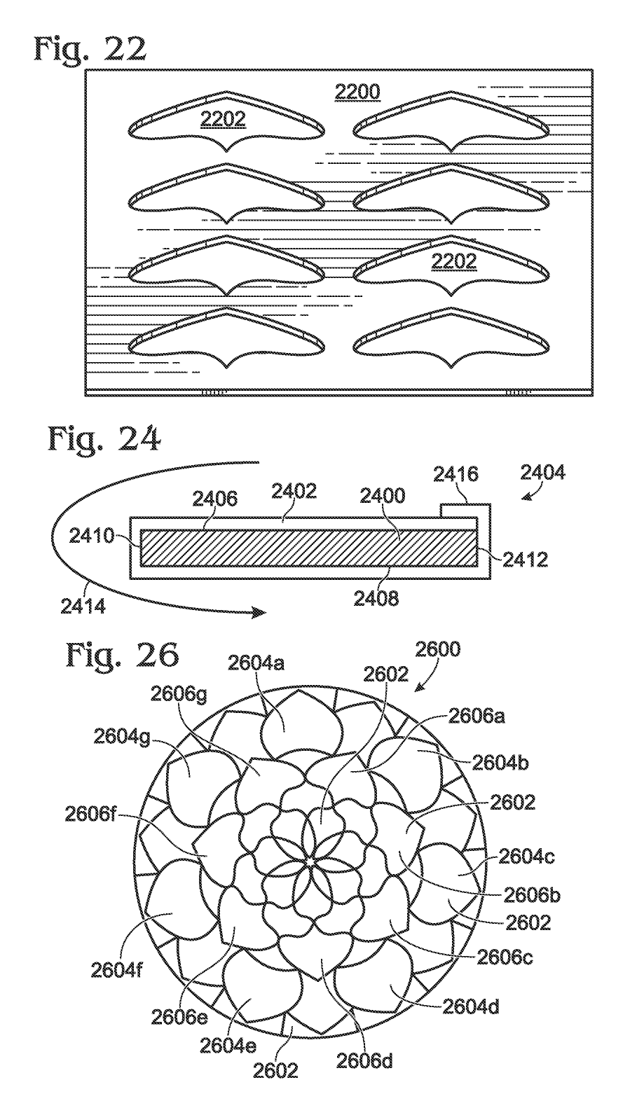

FIG. 22 shows a perspective view of one example of a glass plate 2200 after being pressed according to the present disclosure. As seen in FIG. 22, the glass plate 2200, after pressing according to the present disclosure, contains a number of holes 2202 corresponding to the punches that were pressed against the glass and the corresponding die plate holes used in the tooling. In some examples, the resultant glass plate 2200 (e.g., the excess, leftover glass webbing material) may be a single, unbroken sheet of glass with one or more holes corresponding to the glass parts produced. In other examples, the glass sheet may be broken into a number of smaller pieces after pressing.

FIG. 23 shows a perspective view of one example of a glass part 2300 resulting from the methods disclosed herein as applied to the glass plate 2200 of FIG. 22. As may be seen in FIGS. 22 and 23, which may not be drawn to scale, the glass part 2300 (FIG. 23) is approximately the same shape and size as each of the holes 2202 in glass plate 2200 (FIG. 22). The glass part 2300 may be produced by pressing a punch in the same shape against the molten glass sheet 2200, while the sheet 2200 is positioned adjacent a corresponding die plate having die plate holes (not shown in FIG. 23). The glass part 2300 may be created as a portion of the glass sheet 2200 (FIG. 22) is pressed through a hole in a corresponding die plate as discussed above.

Coating

Raw hot sheet glass often may sag and cool quickly, which may impair the quality of the finished product. Sometimes, if the molten glass cools too rapidly (e.g., from around 1500 degrees Fahrenheit to room temperature in too short an amount of time), it may shatter, thereby destroying the part. Further, molten glass may fuse to hot metal, which may result in pieces of glass being stuck to the tooling that may need to be removed between each stroke cycle.

To combat these potential disadvantageous results, in some examples, a coating may be applied to the glass sheets before they are pressed through the die plate and associated tooling as discussed above. For example and as seen in section view in FIG. 24, a glass sheet 2400, such as a 3 mm thick or 6 mm thick colored glass sheet, may be coated on each side with approximately a 1 mm layer of a coating 2402 (coating 2402 additionally or alternatively may be referred to as a silica-impregnated fiberglass veiling, a fiberglass coating, a fiberglass veiling, a veiling, an impregnated veiling, and/or an impregnated fiberglass veiling), to create a “biscuit” 2404. In some examples, coating 2402 may be a sheet of fiberglass “veiling” (e.g., a fiberglass veil mat) that may be drawn through a silica and plaster mix to create a silica-impregnated fiberglass veiling 2402 that may be “coated” on, or applied to the exterior of the colored glass sheet to be pressed. In some examples, this coating can be refractory on the exterior and may help to keep glass from pooling to a thickness of 6 mm (e.g., to keep the glass sheet at around 3 mm thick in some examples) and/or cooling too quickly. In some examples, the fiberglass coating may help keep the molten glass in a more static state than the uncoated glass would be.

In some examples, a liquid silica-plaster blend may be applied to the fiberglass veiling, after which it may be allowed to cure and dry. When combined with water, the plaster in the mix may harden in a chemical reaction, bonding the silica “flour” to the flexible fiberglass veil mat, thereby creating a hardened, solid web structure. In some examples, a water, silica, and plaster mix may be applied to the fiberglass veiling and then “scraped thin,” removing the excess liquid material, such as with a rubber edge. Once the fiberglass veiling has been fully covered or impregnated with the liquid silica-plaster mix, the veiling may be applied to a top surface 2406 and a bottom surface 2408 of the glass sheet 2400. For example, the impregnated veiling may be applied to the top surface 2406 of the glass sheet 2400, folded around a first edge 2410 of the glass sheet 2400 and applied to the bottom surface 2408 of the glass sheet 2400, and finally folded around a second, opposite edge 2412 back onto itself on the top surface 2406 of the glass sheet 2400 (e.g., applied and folded around the glass sheet 2400 in the direction of arrow 2414). The impregnated fiberglass veiling may essentially stick to itself at a portion of overlap 2416 to remain in place on the glass sheet 2400 while it hardens. Of course, the impregnated fiberglass veiling 2402 may be applied to the glass sheet 2400 in any suitable fashion. FIG. 24 merely shows an example.

In some examples, the silica-impregnated fiberglass veiling 2402 may be applied to the glass sheet 2400 while it is still wet, so that it hardens while surrounding the glass sheet 2400, thereby creating a “biscuit” 2404 of fiberglass-coated glass. In some examples, the dry fiberglass veiling 2402 may be applied to the glass sheet 2400 first, and the liquid silica-plaster mix may be applied to the fiberglass veiling while in place on the glass sheet.

Once the glass sheet 2400 is coated as desired, the entire biscuit 2404 may then be heated. In some examples, the silica may prevent the plaster from disintegrating at high heat (plaster alone may lose its structural abilities over around 1,000° F.). Once hardened, the impregnated fiberglass veiling may maintain its strength at 1,500° F. or higher, and yet may provide very little resistance to the other processes (e.g., is easy to press through; in some examples the fiberglass coating does not significantly increase the forces required to press the glass parts through the die).

In some examples, the glass sheets may be coated on both sides (e.g., the top and bottom of the sheet). In some examples, the glass sheets may be coated on just one side (e.g., pre-make sheets and apply the coating only on top or bottom (one side)).

Any suitable silica and plaster may be used to coat the glass sheet. Examples of suitable materials include silica flour, such as may be obtained from, for example, Oglebay Norton (Cleveland, Ohio) or Georgies Ceramic and Clay Co. (Portland, Oreg.). One example of a suitable plaster may be obtained from Georgies Ceramic and Clay Co. (Portland, Oreg.). In some examples, the percentage of silica in the silica-plaster mix may be from about 10% to about 70% silica. In some examples, the percentage of plaster in the silica-plaster mix may be from about 30% to about 90% plaster. In one specific example, a coating may be made using a mix of about 50% plaster and about 50% silica, mixed with water.

In some examples, the coating may be removed before final processing of the glass parts. For example, before the parts are laid out and fused together in a kiln, an ultrasonic cleaner may be used to remove and/or wash off the coating from the glass parts. Ultrasonic vibrations from an ultrasonic cleaner may explode the silica/fiberglass coating, thereby making it possible for it to be suspended in water and be rinsed off the parts. Thus, in some examples removing the coating material need not require each piece to be handled by a human. In some examples, the parts may be put through a commercial belt-driven tunnel dish-washer to fully remove the coating material. Any leftover coating may appear in the final product as defects. In other examples, the coating may be sandblasted off before kiln fusing. Any suitable method may be used to remove any coating present on the glass parts before fusing.

In some examples, no coating is placed on the glass sheets to be pressed in the presently disclosed tooling set. In some examples, one or more wires (e.g., two wires) may be positioned within (e.g., melted into) the wasted part of glass (e.g., the excess glass webbing material to be recycled), with or without coating the glass sheet. In some examples, the wires may help ensure that the glass may be pulled into the tooling fast enough to process before it cools or sags, even in examples without the silica/plaster/fiberglass veiling.

In another example, a mechanism coupled to the tooling and/or press may allow for uncoated glass to be quickly positioned in place under the press. For example, a spring-loaded door may be configured to open at least partially when the glass sheet has reached the desired temperature. Once the spring-loaded door opens at least partially, it may allow the heated glass to slide into the tooling to a position where stops and/or guides may position or halt the glass without being touched by a human. In this manner, any person that may be operating the press may trigger the mechanism to slide the glass into position under the press and then have enough time to activate the press before uncoated glass cools. Such a mechanism may decrease operating time for each stroke, because the operator may not need to manually place or position the glass sheet within the tooling.

Process

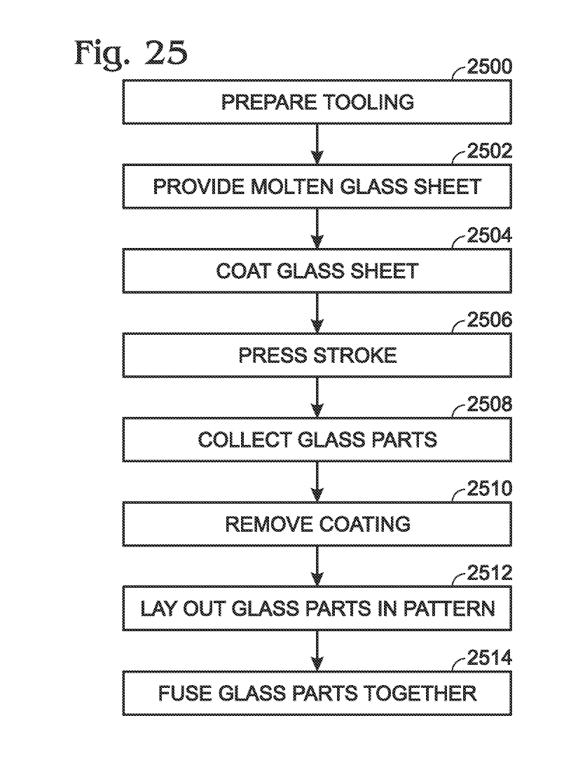

FIG. 25 shows a flow chart of one example of a method of forming a piece of decorative, fused glass parts, according to the present disclosure.

A set of corresponding dies and punches may be prepared to punch out a particular set (e.g., pattern) of glass parts. For example, a punch holder, a stripper plate, a die plate, and a set of punches may be custom-machined with, for example, a wire EDM. The set of plates may be clamped into a die set (e.g., clamped to the upper and low die set plates 210, 212 shown in FIG. 3) to create the tooling, and the tooling may be placed under a press, such as a hydropneumatic press, to exert force on the tooling (step 2500).

A sheet of glass to be extruded into one or more glass parts may be provided (step 2502). In some examples, the glass may be clear glass. In some examples, the glass may be colored glass. Any color of glass sheet may be used. Suitable colors of glass sheets may be selected in accordance with a planned final design of the fused glass parts. For example, a design may be created by hand or with illustrator or design software (e.g., Adobe Illustrator). Punches and dies may be machined to create the discrete parts that make up the final decorative glass design, and appropriate colors of glass sheets may be selected and pressed through the dies to create the parts needed for a particular layout or design. In one particular example, Adobe Illustrator may be used to create a DXF file of the final design (e.g., the layout, or arrangement) of the glass parts. A CNC machine with a wire EDM, waterjet, and/or laser cutter or any other suitable machining method may be used to create the punches and dies necessary to create the parts for the design.

For example, FIG. 26 shows a top plan view of one design, or layout 2600 of glass parts 2602 that may be punched and fused according to the present disclosure to create a finished glass disc, made up of discrete glass parts that are fused together. The glass parts 2602 may be made using the same color glass or different color glass. For example, some glass parts 2604a, 2604b, 2604c, 2604d, 2604e, 2604f, and 2604g may be punched from a first glass sheet of a first color, using at least seven identical first punches and a corresponding first stripper plate and first die plate with at least seven respective first die plate holes, where the first die plate holes and first stripper plate holes are the same shape as the first punches, but sized slightly larger, as discussed above, to allow shearing of the molten glass in that shape through the die plate holes.

Similarly, some other glass parts 2606a, 2606b, 2606c, 2606d, 2606e, 2606f, and 2606g may be punched from a second glass sheet of a second color, using at least seven identical second punches and a corresponding second stripper plate and second die plate. The rest of the glass parts for a given design (e.g., design 2600) may be produced in a similar fashion, with any desired color of glass sheet and appropriate tooling to make the desired parts.

The glass sheets may be any suitable thickness. In some examples, the glass sheets may be from about 0 mm thick to about 10 mm thick. In some examples, the glass sheets may be from about 2 mm thick to about 6 mm thick. In some examples, the glass sheets may be heated to a suitable temperature such that the glass sheets are at least partially molten. For example, the glass sheets may be heated to a temperature at which the glass is slightly molten (e.g., more malleable than room temperature glass), but not yet runny. The range of appropriate temperatures may vary according to the color and/or type of the glass. In some examples, the glass sheets may be heated to a temperature of at least around 1200° F. In some examples, the glass sheets may be heated to a temperature of at least around 1450° F. In some examples, the glass sheets may be heated to a temperature within the range of about 1450° F. to about 1600° F., depending on the color and/or chemistry of the glass. The heating of the glass sheets may be computer-controlled in some examples, to ensure accurate temperatures of the glass sheets.

Returning to FIG. 25, in some examples, the glass sheet may be coated before being placed within a punch and die tooling set (step 2504). For example, each glass sheet may be at least partially coated on at least one surface with a coating that may stabilize the glass plate (e.g., slow cooling of the plate and/or increase stiffness and decrease sagging of the plate). In some examples, the glass sheet may be coated on one or both surfaces with a fiberglass and silica plaster mix. In some examples just one surface of the glass sheet may be coated with a fiberglass and 50/50 silica/plaster mix. In some examples, substantially the entire surface of the glass sheet may be coated with a fiberglass and silica plaster coating. In other examples, a portion of the surface of the glass sheet may be coated with a fiberglass and silica plaster coating.

Sheet glass panels may then be sent through an extrusion process to become parts. For example, the glass sheet (whether coated or not) may be placed within the tooling and subjected to pressure, such as from a hydropneumatic cylinder's stroke pressing on the upper die plate of the tooling (step 2506). In some examples, the heated glass sheet may be positioned between a stripper plate and a die plate of a set of tooling, which in turn may be positioned under, for example, a hydropneumatic cylinder. During the press stroke of the cylinder, plates of the tooling are compressed together and punches are brought down to press the molten glass through holes in the die plate. A shearing action may take place, shearing glass parts out of the molten glass sheet in the shape of the punches and die plate holes. The thusly punched glass parts may fall through the die plate holes and into a space under the die plate, leaving leftover glass webbing between the die and stripper plates of the tooling.

Said glass parts may be collected and further processed (step 2508). In some examples, a handled tray or shelf may be provided in the space under the die plate for the extruded glass parts to fall onto. The tray may then be removed from the tooling and placed, with the glass parts, into an oven for controlled cooling. In some examples, any coating present may be removed subsequent to the cooling of the glass parts (step 2510), such as by an ultrasonic water-based cleaning process. The webbing may be collected for recycling and restamped through a similar process once it has been reformed into recycled glass sheets.

Once all the glass parts required for a particular design (e.g., all the glass parts 2602 for design 2600 of FIG. 26) have been punched through the dies and undergone controlled cooling, the discrete glass parts may be laid out and arranged in the desired pattern (step 2512). For example, the discrete glass parts 2602 (e.g., glass parts 2604 and 2606) may be arranged as desired, according to the design, and then fused together to form a single, solid glass disc having a pattern or appearance substantially similar to that of the design of laid out glass parts (step 2514). Alternatively, the parts may be arranged atop or under another glass sheet or disc, commonly a clear glass disc. A set of 3 mm parts with a 3 mm disc on top or below them may be combined during fusing to form a 6 mm disc that does not “flow” due to an inherent quality of glass tending to be at 6 mm thickness when molten. In another implementation, the parts may be aligned into a 6 mm glass panel that has a 3 mm negative space for the parts, which when melted together forms a continuous sheet 6 mm thick. This technique may be used to embed a pattern in a larger sheet of glass that has been molded via other means (such as pressing when molten or melting into an investment mold.)

The glass parts may be fused in any suitable method, such as by heating in a kiln or oven to a temperature high enough to fuse the glass pieces together. For example, the glass parts may be heated to a temperature between around 1,300° F. and around 1,550° F. or higher for fusing. Final glazing and annealing may be performed, for example, in a tunnel or bell kiln. Disclosed methods and devices may eliminate the need for a grinding or polishing step in some examples. In some examples, the thickness of the glass parts produced is approximately 6 mm and thus may resist spreading or pooling in a kiln during fusing because of the natural properties of glass. In some examples, one or more layers of clear glass may be added to a layer of discrete parts to form a combined thickness of around 6 mm, which may then be melted together as one assembly.

Parts that are fused into discs then may be pressed, slumped, or otherwise modified to form finished products, such as glasses, vases, bowls, etc, having the design as formed in the disclosed process. Alternatively, the fused disc itself may be the finished product, and may be displayed, such as on a stand or light box.

The press and tooling according to the present disclosure thus may reduce the time associated with cutting glass, enabling reduced costs for glass patterns that stand alone or are integrated into other glass manufactured objects, while at the same time insuring repeatability to degrees of accuracy and with high yields not available through other methods. These benefits may enable lower costs for glass objects that are comprised of parts created through these means when compared to alternate methods of glass cutting.

In view of the many possible examples to which the principles of the disclosed invention may be applied, it should be recognized that the illustrated examples are only preferred examples of the invention and should not be taken as limiting the scope of the invention. Rather, the scope of the invention is defined by the following claims. I therefore claim as my invention all that comes within the scope and spirit of these claims.

1. A device for creating one or more glass parts from a glass sheet, comprising:
one or more punches held in place by a punch holder;
a die plate having a die plate thickness, wherein the die plate comprises one or more die plate holes, each die plate hole extending through the die plate thickness, wherein each of the die plate holes is configured to correspond to one respective punch of the one or more punches, and wherein each die plate hole is sized to be at least slightly larger than the respective punch so that each respective punch can fit through a respective die plate hole; and
an upper die set plate configured to transfer force to the punches, thereby configured to press the punches into the glass sheet and cause the one or more glass parts to shear from the glass sheet through the die plate holes, thereby being configured to create the one or more glass parts.

2. The device of claim 1, further comprising a stripper plate positioned between the one or more punches and the glass sheet, wherein the stripper plate comprises one or more stripper plate holes corresponding to the punches and the die plate holes, wherein each stripper plate hole is at least slightly larger than each corresponding punch, and wherein the stripper plate is configured to prevent the glass sheet from adhering to the punches.

3. The device of claim 1, further comprising a lower die set plate positioned opposite the upper die set plate.

4. The device of claim 2, further comprising a punch backer coupled to the punch holder and the upper die set plate.

5. The device of claim 1, further comprising one or more alignment posts configured to keep the punch holder, the die plate, and the upper die set plate in alignment with one another.

6. The device of claim 3, further comprising one or more spacers positioned between the die plate and the lower die set plate, wherein the spacers are configured to create at least one empty space between the die plate and the lower die set plate.

7. The device of claim 6, wherein the at least one empty space is configured to receive the one or more glass parts that are pressed through the die plate holes.

8. The device of claim 4, further comprising one or more brackets configured to allow for changing of one or more of the punch holder, the punch backer, the die plate, and the stripper plate.

9. The device of claim 2, further comprising one or more compression springs that are configured to press the stripper plate and the punch holder away from one another when not compressed by an external force.

10. The device of claim 1, further comprising a coupling coupled to the upper die set plate and configured to interface with a hydropneumatic cylinder.

11. The device of claim 1, further comprising a hydropneumatic cylinder configured to press the one or more punches against the glass sheet with sufficient force to shear the glass sheet through the die plate holes, thereby creating the one or more glass parts.

12. A device for creating one or more glass parts from a glass sheet, comprising:
a hydropneumatic cylinder press configured to impart pressure on an upper die set plate;
a punch holder coupled to the upper die set plate, the punch holder configured to hold a plurality of punches;
a stripper plate, wherein a first stripper plate surface is separated from the punch holder by a plurality of compression springs, wherein the stripper plate comprises a plurality of stripper plate holes that extend through the entire thickness of the stripper plate from the first stripper plate surface to an opposite, second stripper plate surface, wherein each of the stripper plate holes is of the same shape as each of the punches, wherein each of the stripper plate holes is at least slightly larger than each of the punches, and wherein the stripper plate is positioned such that each of the plurality of stripper plate holes is concentrically aligned with a respective one of the plurality of punches;
a die plate having an upper die plate surface and a lower die plate surface, and a plurality of die plate holes extending from the upper die plate surface to the lower die plate surface, wherein each of the die plate holes is of the same shape as each of the punches, wherein each of the die plate holes is at least slightly larger than each of the punches, and wherein the die plate is positioned such that each of the plurality of die plate holes is concentrically aligned with a respective one of the plurality of punches;
a glass sheet positioned between the second stripper plate surface and the upper die plate surface; and
a lower die set plate spaced from the lower die plate surface via at least one spacer, wherein the upper die set plate is configured to transfer forces from the hydropneumatic cylinder to press the punches against the glass sheet, thereby shearing one or more glass parts from the glass sheet through the die plate holes, and wherein the lower die set plate comprises a receiving surface configured for receiving the one or more glass parts as they are pressed through the die plate holes.

13. A method of creating a glass object, comprising:
providing a first glass sheet;
heating the first glass sheet until it is molten;
positioning the first glass sheet, while molten, within a tooling set, wherein said tooling set comprises at least one punch and a die plate having at least one die plate hole corresponding to the at least one punch; and
pressing the at least one punch against the first glass sheet with enough force to shear one or more portions of the first glass sheet through the at least one die plate hole, thereby separating the first glass sheet into one or more glass parts shaped like the at least one punch and a remaining glass webbing in the tooling set.

14. The method according to claim 13, further comprising coating the first glass sheet with fiberglass impregnated with a silica and plaster mix.

15. The method according to claim 14, further comprising removing the coating with an ultrasonic cleaner and water.

16. The method according to claim 13, further comprising cooling of the one or more glass parts.

17. The method according to claim 13, wherein the pressing comprises pressing via a hydraulic, pneumatic, electrical, and/or magnetic cylinder, and/or via manual force.

18. The method according to claim 13, further comprising:
removing the at least one punch and the die plate from the tooling set;
replacing the at least one punch with at least one second punch;
replacing the die plate with a second die plate;
providing a second glass sheet; and
pressing the at least one second punch against the second glass sheet.

19. The method according to claim 13, further comprising creating a desired pattern of arranged glass parts in a design software program.

20. The method according to claim 19, further comprising machining the at least one punch and the die plate to create specific glass parts for the desired pattern of arranged glass parts.

21. The method according to claim 18, wherein the first glass sheet comprises a first color, wherein the second glass sheet comprises a second color, and wherein the first color is different from the second color.

22. The method according to claim 13, wherein the at least one punch comprises a plurality of punches, wherein the at least one die plate hole comprises a plurality of die plate holes, wherein the one or more glass parts comprises a plurality of glass parts, and wherein the tooling set is configured to cut the plurality of glass parts simultaneously.

23. The method according to claim 13, further comprising arranging the one or more glass parts into a design or pattern.

24. The method according to claim 23, further comprising heating the pattern of glass parts in a kiln to a temperature sufficient to fuse the glass parts together.
